(19) United States
(12) Patent Application Publication
(10) Pub. No.: US 2011/0178247 A1
(43) Pub. Date: Jul. 21, 2011

(54) EXTRUDABLE SHAPE MEMORY POLYMER

(75) Inventors: Tat H. Tong, Bellbrook, OH (US); Lisa A. Bartlett, Beavercreek, OH (US)

(73) Assignee: CORNERSTONE RESEARCH GROUP, INC, Dayton, OH (US)

(21) Appl. No.: 13/119,021

(22) PCT Filed: Sep. 14, 2009
(86) PCT No.: PCT/US2009/056799

§ 371 Date: Mar. 15, 2011

Related U.S. Application Data
(60) Provisional application No. 61/097,561, filed on Sep. 17, 2008.

(51) Int. Cl. C08F 299/04; C08L 67/02; C08L 31/04

(52) U.S. Cl. 525/176

(57) ABSTRACT

The presently disclosed formula utilizes a composition of a rigid, semi-crystalline polymer, such as polybutylene terephthalate, and an amorphous polymer, such as poly(vinyl acetate), to create a thermoplastic shape memory polymer that can be processed through methods such as extrusion and injection molding, which require high heat. The polybutylene terephthalate acts as a cross-linker for the poly(vinyl acetate), therefore the thermoplastic shape memory polymer that is created has a much higher melting point and greater heat stability than other shape memory polymers.

### CROSS REFERENCE TO RELATED APPLICATIONS

This application claims priority from U.S. provisional application Ser. No. 61/097,561 filed Sep. 17, 2008.

### BACKGROUND OF THE INVENTION

1. Field of the Invention

The presently disclosed formula and method relate to a shape memory polymer composition, its manufacture, and application.

2. Description of Related Art

Dynamic modulus resins are resins which undergo a large change in the elastic modulus of the resin at a predetermined transition temperature. One example of a dynamic modulus resin is a shape memory polymer. Shape memory polymers (SMPs) were developed about twenty-five years ago and have been the subject of commercial development within the last fifteen years. SMPs derive their name from their inherent ability to return to their original “memorized” shape after undergoing a shape deformation. SMPs that have been preformed can be deformed to almost any desired shape above their glass transition temperature (T_{g}). The SMP must be quenched below the T_{g} while maintained in the desired shape to “lock” in the deformation. Once the deformation is locked in, the polymer network cannot return to a relaxed state due to the existence of a thermal aspiration barrier. The SMP will hold its deformed shape indefinitely until it is heated above its T_{g}. Once heated above its T_{g}, the stored mechanical strain is released and the SMP will return to its preformed or memory state.

Several polymer types exhibit shape memory properties. These polymers are either thermoplastic or thermoset. While thermoset SMPs have the advantage of superior shape memory performance, they cannot be processed using extrusion and injection molding techniques which are standard for processing thermoplastics.

It has been reported in Macromolecular Materials and Engineering 2006, vol. 291, 1201-1207 that poly(vinylidene fluoride) (PVDF), a rigid, semi-crystalline polymer, is miscible with acrylic rubber (ACM), an amorphous polymer, in an ACM-rich system. The results reported indicate that PVDF remains semi-crystalline in the blend and the crystallized PVDF crystals can act as the cross-link points for the ACM elastomer. This article has been used to produce elastomers based on ACM/PVDF blends. PVDF, however, has a lower melting point which precludes the use of processing conditions with very high temperatures.

A patent application, Kagawa, U.S. Pat. App. No. 2006/0051540, discloses a material made solely of polybutylene terephthalate which is meant to exhibit shape memory behavior after being set between a thin laminate and cured in a curled or warping mode; the end product does not exhibit elongation. The shape memory behavior is likely to be different than that of other SMPs due to the lack of other compositional elements. Because there is no cross-linking, physical or chemical, between the polybutylene terephthalate and another element, there is likely to be less stability and poorer shape memory properties than are exhibited by polymers which incorporate and cross-link with other elements, such as amorphous polymers.

U.S. Pat. No. 6,368,533, issued on Apr. 9, 2002 to Morman, discloses an extrusion process of prepolymer compositions made up of polyurethane and silicone polymers. Morman allows for ten percent (10%) or less cross-linking during extrusion and delays cross-linking of the polyurethane and silicone polymers until the final thermoset article, in this case a film or fiber, has been formed. The product created by this composition and process is a thermoset film, fiber, or fibrous web and cannot be as easily shaped into various three-dimensional geometries through injection molding as a thermoplastic SMP, which may be heated above its melt temperature and reshaped.

The use of thermosetting polymers in an extrusion machine is typically not recommended. If the thermoset cures within the extruder it can be expensive and time intensive to remove the solidified polymer. Thermoplastic compounds are routinely processed in extruder machines and also injected molded. There is a need for an SMP formula which is thermoplastic, with a high melting point and good heat stability to provide a large operating temperature range. The SMP formula needs to be able to be processed by the current commercial manufacturing infrastructures, such as extrusion and injection molding, thereby facilitating the dissemination of SMP technology into the commercial marketplace.

### SUMMARY OF THE INVENTION

The subject of the presently disclosed formula is to utilize a composition of a rigid, semi-crystalline polymer such as polybutylene terephthalate and an amorphous polymer, such as poly (vinyl acetate) to create a thermoplastic shape memory polymer that can be processed through current commercial manufacturing methods such as extrusion and injection molding.

The rigid, semi-crystalline polymer acts as a physical cross-linker for the more flexible, amorphous polymer which allows the composition to have thermoplastic properties. By using polybutylene terephthalate as the rigid, semi-crystalline polymer, the thermoplastic SMP that is created by the formulation has a much higher melting point and, therefore, much greater heat stability and an increased stability at operating temperature.

Shape memory polymer is typically a thermoset, and therefore can not be processed via traditional thermoplastic processing techniques such as extrusion or injection molding. The thermoset nature of SMP has been viewed as a tremendous disadvantage by many industries where shape memory capabilities would be an asset, but thermoplastic processing is the standard. A thermoplastic SMP processed via commercial mass manufacturing processes such as extrusion or injection molding would be beneficial to such industries.

### DETAILED DESCRIPTION OF EXEMPLARY EMBODIMENTS

Injection molding and extrusion are widely used manufacturing processes suited to the manufacture of specific articles. The nature of the article, such as required precision of spatial dimensions, uniformity of material thickness, small articulate features, etc., may require the article to be manufactured through injection molding.

The popularity of extrusion and injection molding processes would allow manufacturers to easily incorporate a thermoplastic SMP into the current industry infrastructure; SMP developers should therefore tailor their formulations to accommodate specific applications and the use of these common processes.

To formulate an SMP with good shape memory behavior that is easily processed through extrusion and injection molding, the presently disclosed formula employs a blend of a rigid, semi-crystalline polymer and an amorphous polymer. The chains of the amorphous polymer are cross-linked through physical interaction with the crystallites of the semi-crystalline polymer. The glass transition temperature, T_{g}, is a function of the amorphous polymer's elasticity. A temperature exists at which the elasticity of the formed article will increase and allow deformation to a second desired shape. This increase in elasticity is a result of the amorphous polymer chains becoming flexible while still being firmly cross-linked with the semi-crystalline polymer.

The crystalline polymer (in this case polybutylene terephthalate) crystallized into very sparse and loose spherulites with the amorphous molecular chains (in this case poly(vinyl acetate) incorporated into the crystalline polymer lamellae.) These micro-crystals were dispersed in the amorphous matrix and act as the physical cross-link points for the matrix. This reaction is a physical cross-linking, not a chemical cross-linking, so functional groups are not applicable.

A rigid, crystalline polymer [i.e. polybutylene terephthalate] can act as a physical cross-linker for a flexible, amorphorous polymer [ie poly(vinyl acetate)], producing a thermoplastic SMP. This type of material can be blended in a Brabender-type mixer and heat pressed to form samples, or mixed via any type of melt-process through a twin-screw extruder.

Theoretical Tg's are determined by the Tg's of the component polymers and their weight ratios via the Fox Equation (1/Tg_{blend}=W_{A}/Tg_{A}+W_{B}/Tg_{B}). In addition cross-link density (here determined by the amount of crystalline polymer) also affects Tg (the higher the cross-link density, the higher the Tg).

The melt temperature of the blend is a function of the semi-crystalline polymer and the physical interaction of its crystallites and the amorphous polymer chains. A temperature exists at which the crystallites melt and relax the physical interaction between the crystallites and amorphous chains. The relaxation of the cross-links creates a liquefied composition that may be remolded as desired and which, once cooled, will not exhibit any shape memory behavior directed to a previously molded shape.

In this manner, an SMP composition is formulated which exhibits good shape memory behavior but can also be re-molded into new base shapes. This ability also accommodates the use of manufacturing processes typical of thermoplastic compounds, processes widely used in the current manufacturing infrastructure.

In the presently disclosed formulation, useful polymers include poly (vinylidene fluoride), polyethylene, polypropylene, acetals, nylons, most thermoplastic polyesters, and in some cases polyvinyl chloride. The high melting temperature of PBT imbues a high melting temperature onto the SMP composition, creating articles with wide operating temperature ranges.

Less preferred semi-crystalline polymers are other semi-crystalline polyesters and semi-crystalline polyamides. Other semi-crystalline polyesters include, but are not limited to, other poly(alkylene terephthalate), poly(1,2-ethylene terephthalate), and co-polymers thereof. Semi-crystalline polyamides include, but are not limited to, Nylon 6,6, Nylon 6, Nylon 12, and co-polymers thereof.

In the presently disclosed formulation, a preferred amorphous polymer is poly(vinyl acetate). Less preferred amorphous polymers are vinyl polymers, poly(alkyl methacrylate), poly(alkyl acrylate), poly(hydroxylaminoether), poly(hydroxyether), and polyarylate. Vinyl polymers include, but are not limited to, poly(vinyl pyridine), polyacrylamide, poly(vinyl pyrrolidone), and partially hydrolyzed poly(vinyl alcohol). Poly(alkyl methacrylates) include, but are not limited to, poly(methyl methacrylate) and poly(ethyl methacrylate). Poly(alkyl acrylates) include, but are not limited to, poly(methyl acrylate) and poly(ethyl acrylate).

A preferred embodiment of the presently disclosed formulation can be prepared by the following procedure.

### Example 1

60.0 grams of Poly(vinyl acetate) of average Mw 500,000 by GPC, with Molecular Formula [CH2CH(O2CCH3)]n, obtained from Sigma-Aldrich, product code #387932 and 40.0 grams of Poly(l,4-butylene terephthalate) molecular formula of average Mw ˜38,000, obtained from Sigma-Aldrich, product code #190942 in solid, pelletized form are mixed in a twin screw extruder by using two automatic feeders that are set to different feed rates which result in a final compound with specific weight ratios of the feeding resins. The extrusion machine used was a Thermo Electron Corporation, model Prism TSE 16 TC. The extruder screw drive was set to 40 rpm.

The six temperature zones, listed in order from the hopper to the die, were:
Zone 1: 210° C.
Zone 2: 240° C.
Zone 3: 240° C.
Zone 4: 240° C.
Zone 5: 230° C.
Zone 6 (Die): 230° C.

The preferred weight ratio of Poly(vinyl acetate) to Poly(1,4-butylene terephthalate) is 3 to 2. A less preferred weight ratio of Poly(vinyl acetate) to Poly(1,4-butylene terephthalate) is 7 to 3. The aforementioned extruder settings are those most preferred for the extrusion process.

Other polymers, including co-polymers and individual polymer resins, may be added to the Poly(vinyl acetate) and Poly(1,4-butylene terephthalate) blend to tune the properties of the extruded polymer product. Some examples of tunable properties are T_{g}, melt temperature, hardness, and the physical properties typically reported by chemical developers.

What is claimed is:

1. A shape memory polymer comprising a polymer blend of a semi-crystalline polyester and an amorphous polymer selected from the group consisting of vinyl polymers, poly(alkyl methacrylate), poly(alkyl acrylate), poly(hydroxylaminoether), poly(hydroxyether), and polyarylate, wherein said polymer blend is a shape memory polymer.

2. The shape memory polymer of claim 1 wherein said semi-crystalline polyester is a poly(alkylene terephthalate).

3. The shape memory polymer of claim 1 wherein said amorphous polymer is poly(vinyl acetate).

4. The shape memory polymer of claim 2 wherein said poly(alkylene terephthalate) is poly(1,4-butylene terephthalate).

5. The shape memory polymer of claim 1 wherein the shape memory polymer has a weight percent between twenty (20) and sixty (60) weight percent of said semi-crystalline polyester in said polymer blend.

6. The shape memory polymer of claim 5 wherein the weight percent of said semi-crystalline polyester in said polymer blend is forty (40) weight percent.

7. The shape memory polymer of claim 5 wherein said semi-crystalline polyester is a poly(alkylene terephthalate).

8. The shape memory polymer of claim 7 wherein said poly(alkylene terephthalate) is poly(1,4-butylene terephthalate).

9. The shape memory polymer of claim 5 wherein said amorphous polymer is poly(vinyl acetate).

10. The shape memory polymer of claim 1 wherein the shape memory polymer contains at least one modifying polymer.

11. The shape memory polymer of claim 10 wherein said modifying polymer is a co-polymer.

12. The shape memory polymer of claim 2 wherein said poly(alkylene terephthalate) and said amorphous polymer are cross-linked with each other during manufacture of said shape memory polymer.

13. A method of making a shape memory polymer comprising:
a polymer blend of a semi-crystalline polyester and an amorphous polymer selected from the group consisting of vinyl polymers, poly(alkyl methacrylate), poly(alkyl acrylate), poly(hydroxylaminoether), poly(hydroxyether), and polyarylate;
processing said polymer blend such that the semi-crystalline polyester and amorphous polymer cross-link with each other, forming a shape memory polymer.

14. The method of claim 13 wherein said processing is by means of an extrusion machine.

15. The method of claim 14 wherein said extrusion machine has twin screws.

16. The method of claim 13 wherein said processing of said polymer blend occurs between 200 and 280 degrees Celsius.

17. The method of claim 13 wherein the shape memory polymer has a weight percent between twenty (20) and sixty (60) weight percent of semi-crystalline polyester in said polymer blend.

18. The method of claim 17 wherein the weight percent of semicrystalline polyester in said polymer blend is 40 percent (40%).

19. The method of claim 13 wherein said semi-crystalline polyester is a poly(alkylene terephthalate).

20. The method of claim 19 wherein said poly(alkylene terephthalate) is poly(1,4-butylene terephthalate).

21. The method of claim 13 wherein said amorphous polymer is poly(vinyl acetate).

22. The method of claim 13 wherein said shape memory polymer contains at least one modifying polymer.

23. The method of claim 22 wherein said modifying polymer is a co-polymer.
